(19) United States
(12) Patent Application Publication
(10) Pub. No.: US 2014/0085897 A1
(43) Pub. Date: Mar. 27, 2014

(54) SOUND ACTIVATED FOAM STICK BATON

(71) Applicant: Cool Glow LLC, Coppell, TX (US)

(72) Inventors: Hunaid Hakam, Dallas, TX (US); Glenna Morgio, Dallas, TX (US)

(73) Assignee: Cool Glow LLC, Coppell, TX (US)

(21) Appl. No.: 14/039,867

(22) Filed: Sep. 27, 2013

Related U.S. Application Data
(60) Provisional application No. 61/706,266, filed on Sep. 27, 2012.

(51) Int. Cl. F21V 33/00

(52) U.S. Cl. CPC F21V 33/00
USPC 362/253; 29/825

(57) ABSTRACT

According to one aspect of the present disclosure, a sound activated object comprises an elongated foam element; a light module insertable at least partially into an interior cavity of the foam element; and a circuit configured to control illumination of one or more light elements of the light module via sound recognition.

### BACKGROUND

There are many types of light up objects and types of novelty items, such as headgear, necklaces, bracelets, drinking cups, etc. These types of devices are popular gift items and oftentimes may be found at amusement parks, parties and other types of social events.

### BRIEF SUMMARY

According to one aspect of the present disclosure, a sound activated object in the form of a foam stick baton is disclosed. The sound activated object comprises an elongated foam element; a light module insertable at least partially into an interior cavity of the foam element; and a circuit configured to control illumination of one or more light elements of the light module via sound recognition.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is a diagram illustrating an embodiment of a sound activated object according to the present disclosure;

FIG. 2 is a diagram illustrating the sound activated object of FIG. 1 with a portion of an outer wall removed according to the present disclosure;

FIG. 3 is a diagram illustrating section view of the sound activated object of FIG. 1 taken along the line 3-3 of FIG. 1; and

FIG. 4 is a block diagram illustrating a light module of the sound activated object according to the present disclosure.

### DETAILED DESCRIPTION

Embodiments of the present disclosure provide a sound activated object comprises an elongated foam element; a light module insertable at least partially into an interior cavity of the foam element; and a circuit configured to control illumination of one or more light elements of the light module via sound recognition.

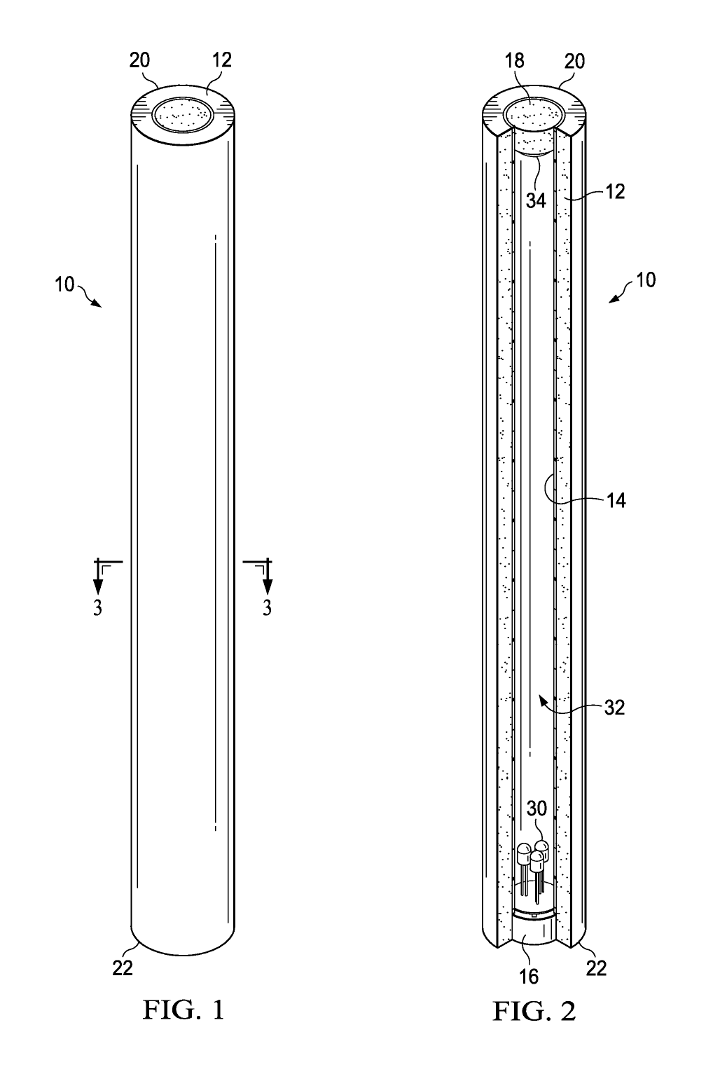

With reference now to the Figures and in particular with reference to FIGS. 1 and 2, exemplary diagrams of a sound activated foam stick baton 10 according to the present disclosure are provided. FIG. 1 is a diagram illustrating an embodiment of baton 10 according to the present disclosure, and FIG. 2 is a diagram illustrating baton 10 of FIG. 1 with a portion of an outer foam element 12 removed. In the embodiment illustrated in FIGS. 1 and 2, baton 10 is depicted as a substantially circular, elongate member (e.g., a cylindrical member); however, it should be understood that baton 10 may be configured having other shapes (e.g., an elongate conical shape, elliptical, square, rectangular, etc.). In the illustrated embodiment, baton 10 comprises outer foam element 12, an inner reflective element 14, a light module 16 and a plug 18. Foam element 12 may comprise any type of foam structure (e.g., a molded, cell-based foam material) being at least semi-rigid to enable foam element 12 to retain a desired shape. Foam element 12 is formed having a desired thickness and/or density to enable light to be transmitted therethrough. Foam element 12 may be annular in shape (e.g., having inner and outer diameters) or may be formed having other shapes. Foam element 12 may be formed as a continuous element extending about a circumference thereof (e.g., a tube) or may be formed from a flat/planar foam material (or a material being partially circular/arched in shape) that may be formed into a desired shape and have ends/portions secured to each other (e.g., a flat/planar shape folded/rolled into a tube and secured (e.g., via adhesive, heatstaking, etc.).

In the illustrated embodiment, baton comprises opposite ends 20 and 22. In FIGS. 1 and 2, plug 18 is disposed in and/or is otherwise used to seal or close end 20. Light module 16 is disposed in and/or is otherwise used to seal or close end 22. Plug 18 may comprise a foam material (e.g., similar to the material used to form foam element 12) or may be formed from a different material. Plug 18 may be configured to be light-transmissive (e.g., similar to foam element 12) or non-transmissive (e.g., opaque). It should be understood that light module 16 may be located at other locations along a length of foam element 12 (e.g., insertable into a medial location along a length of foam element 12) and/or there may be multiple instances of light module 16 (e.g., inserted into each of ends 20 and 22).

Light module 16 comprises one or more light elements 30 (e.g., light emitting diodes (LEDs)) powered by an onboard power supply, such as replaceable or non-replaceable batteries. Light module 16 is insertable into end 22 of foam element 12 such that light elements 30 are located within in interior cavity 32 of baton 10. In some embodiments, light module 16 may comprise a plurality of light elements 30 of a number of different colors.

In the illustrated embodiment, baton 10 further includes reflective element 14 disposed proximate to an interior surface of foam element 12. In the embodiment of FIGS. 1 and 2, reflective element 14 comprises a shape corresponding to a shape of foam element 12 (e.g., a tubular shape) and extends substantially along an entire length of foam element 12. Reflective element 14 may comprise a plastic tube or other type of material configured to aid in light reflection and dispersion within interior cavity 32, thereby resulting in greater light transmission uniformity through foam element 12 along a length or longitudinal direction of baton 10 and/or increase the intensity/magnitude of light emitted through foal element 12. In some embodiments, reflective element 14 may comprise a coating (e.g., a finely dispersed coating) that provides some reflectivity while also enabling light to pass through element 14. In the illustrated embodiment, a reflective element 34 is located on an interiorly disposed surface of plug 18. Reflective element 34 may be configured having properties similar to reflective element 14 or may be configured as a completely opaque element being highly reflective (e.g., having a mirrored surface facing interior cavity 32). Thus, in some embodiments, reflective elements 14 and/or 34 are configured have some degree of reflective properties while, in some cases, enabling light to be transmitted therethrough to enable light generated by light elements 30 to be emitted through foam element 12 and/or plug 18.

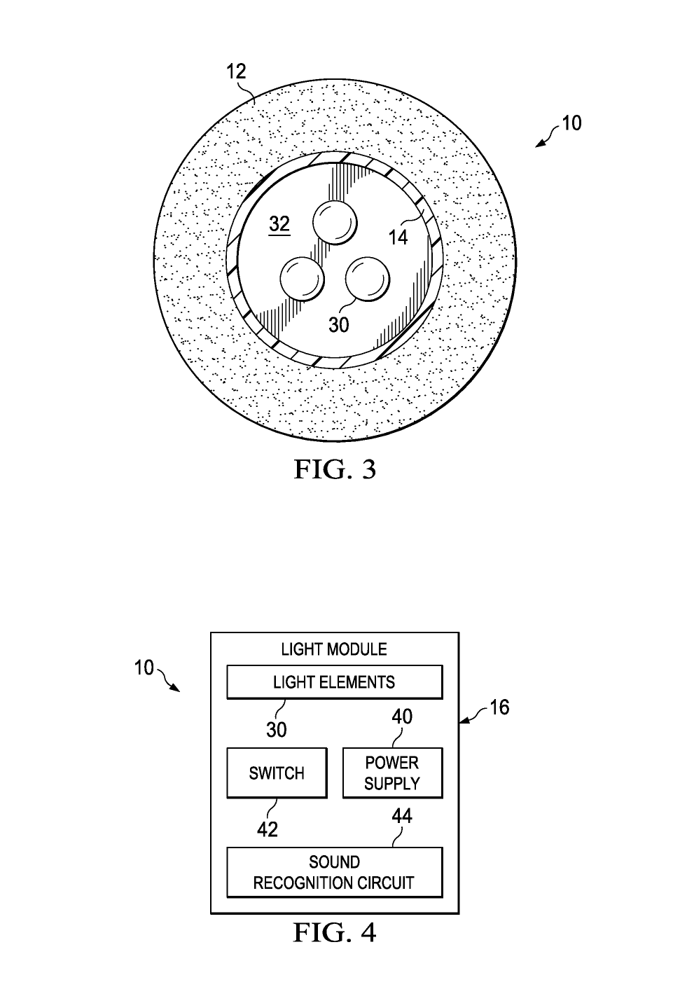

FIG. 3 is a diagram illustrating a section view of baton 10 taken along the line 3-3 of FIG. 1 according to the present disclosure. In the embodiment illustrated in FIG. 3, reflective element 14 is located concentric with foam element 12 and is configured having a thinner cross-section than a cross-section of foam element 12. In some embodiments, reflective element 14 also provides a level of rigidity to baton 10 to enable baton 10 to maintain a desired shape. In some embodiments, foam element 12 may be formed having a tubular shape such that a tubular-shaped reflective element 14 may be slid into the interior portion of foam element 12

FIG. 4 is a block diagram illustrating an embodiment of light module 16 according to the present disclosure. In the embodiment illustrated in FIG. 4, light module 16 comprises a power supply 40 (e.g., replaceable or non-replaceable batteries), a switch 42, light element(s) 30 and a sound recognition circuit 44. Switch 42 may be used to switch light module 16 on and off (e.g., to deliver power to circuit 44 and/or light elements 30). Circuit 44 may comprise an integrated circuit and/or microprocessor-based chip having sound and/or voice-recognition capability/functionality such that circuit 44 may control the activation and/or illumination of one or more light elements 30 based on detected sounds/voices. For example, in some embodiments, circuit 44 may comprise code, firmware, logic and/or an algorithm executable by a processor unit for processing detected sounds/voices and controlling activation and/or illumination of certain light elements. In some embodiments, circuit 44 may be configured to cause power to be delivered to, or cease delivery of power to, certain light elements 30 in response to certain sounds. For example, in some embodiments, light module 16 may comprise three light elements 30 each of a different color (e.g., one red LED, one yellow LED, and one blue LED). In response to detecting a sound and/or voice command of “red,” circuit 44 causes the red LED to be illuminated. Circuit 44 may also be configured to cause multiple LED's to be illuminated in response to detecting a particular voice/sound command (e.g., illuminating both the red and blue LEDs to produce a purple or magenta light to be emitted from baton 10).

In some embodiments, circuit 44 may be configured to control a rate of light element 30 illumination. For example, in some embodiments, in response to detecting a sound/voice command of “fast” or “slow”, circuit 44 may be configured to increase or decrease, respectively, a rate of activation/deactivation of light elements 30. Circuit 44 may be configured with multiple rates such that in response to repeated “fast” voice commands, circuit 44 repeatedly increases a level of rate of activation/deactivation of light elements 30, and vice versa for repeated “slow” commands. It should be understood that the type or content of a particular command and/or sound for controlling light element 30 activation and deactivation may vary.

In some embodiments, based on a particular sound and/or command detected by circuit 44, circuit 44 may be configured to activate/deactivate light element(s) 30 according to a particular pattern (e.g., a single, brief illumination, followed by two, brief illuminations, etc.). Circuit 44 may also be configured with multiple, different patterns that may be activated/selected by a user of baton 10 based on the particular command and/or sound detected by circuit 44. The particular pattern may also include activating and deactivating certain colors of light elements 30 (e.g., cycling through the different colors of light elements 30 according to a defined and/or random pattern).

Thus, embodiments of baton 10 of the present disclosure may include a number of different light patterns and/or colors that may be controlled through sound/voice commands/detection. Baton 10 may be configured having a number of different sizes and/or shapes. Additionally, in some embodiments, light reflective elements may be used to increase the intensity of light emitted by baton 10 as well as providing greater uniformity of light emitted along baton 10.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A sound activated object, comprising:
an elongated foam element;
a light module insertable at least partially into an interior cavity of the foam element; and
a circuit configured to control illumination of one or more light elements of the light module via sound recognition.

2. The object of claim 1, further comprising at least one reflective element disposed within the interior cavity.

3. The object of claim 1, wherein the foam element comprises a first end and a second end, and wherein the light module is insertable into the first end, and wherein a plug is insertable into the second end.

4. The object of claim 3, further comprising a reflective element disposed on a surface of the plug facing the interior cavity.

5. The object of claim 1, further comprising an elongated reflective element disposed within the foam element and extending along a length of the foam element.

6. The object of claim 5, wherein the reflective element comprises a plastic tube disposed against an interior surface of the foam element.

7. The object of claim 1, wherein the circuit is configured to control a pattern of illumination of the one or more light elements in response to a select sound.

8. The object of claim 1, wherein the circuit is configured to control illumination of a particular color of the one or more light elements in response to a select sound.

9. The object of claim 1, wherein the foam element comprises a cylindrical foam element.

10. A method for manufacturing a sound activated object, comprising:
providing an elongated foam element; and
inserting a light module at least partially into an interior cavity of the foam element, the light module comprising a circuit configured to control illumination of one or more light elements of the light module via sound recognition.

11. The method of claim 10, further comprising disposing at least one reflective element within the interior cavity.

12. The method of claim 10, wherein the foam element comprises a first end and a second end, and:
inserting the light module into the first end; and
inserting a plug into the second end.

13. The method of claim 12, further comprising disposing a reflective element on a surface of the plug facing the interior cavity.

14. The method of claim 10, further comprising disposing an elongated reflective element within the foam element and extending along a length of the foam element.

15. The method of claim 14, wherein disposing the elongated reflective tube within the foam element comprises disposing a plastic tube against an interior surface of the foam element.

16. The method of claim 10, further comprising configuring the circuit to control a pattern of illumination of the one or more light elements in response to a select sound.

17. method of claim 10, further comprising configuring the circuit to control illumination of a particular color of the one or more light elements in response to a select sound.

18. The method of claim 10, wherein providing the foam element comprises providing a cylindrical foam element.
